(19) United States
(12) Patent Application Publication
(10) Pub. No.: US 2015/0106469 A1
(43) Pub. Date: Apr. 16, 2015

(54) ELECTRONIC DEVICE WITH DATA CACHE FUNCTION AND RELATED METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: PENG WANG, Shenzhen (CN)

(21) Appl. No.: 14/476,298

(22) Filed: Sep. 3, 2014

(30) Foreign Application Priority Data
Oct. 15, 2013 (CN) 2013104813406

(51) Int. Cl. H04L 29/08; G06F 17/30

(52) U.S. Cl. CPC H04L 67/2842; G06F 17/30902
USPC 709/213

(57) ABSTRACT

An electronic device with a data cache function includes a memory and a processor. The processor caches video data to the memory when a webpage is opened to play a network video, divides the cached video data into a plurality of sub videos, transfers the plurality of sub-videos to an external storage equipment for storing from the memory, and joins the plurality of sub-videos from the external storage equipment and the cached video data in the memory to form a joined video.

### CROSS-REFERENCE TO RELATED APPLICATIONS

This application claims priority to Chinese Patent Application No. 201310481340.6 filed on Oct. 15, 2013, the contents of which are incorporated by reference herein.

### FIELD

The present disclosure relates to electronic devices, and particularly to an electronic device and a method having data cache function.

### BACKGROUND

Electronic devices usually automatically download video data to a memory when playing a network video. It is easy to take up storage space of the memory for storing the downloaded video data.

### BRIEF DESCRIPTION OF THE DRAWINGS

FIG. 1 illustrates a block diagram of an embodiment of an electronic device.

FIG. 2 illustrates divided cached data according to a first predetermined period of time in a first embodiment.

FIG. 3 illustrates divided cached data according to the first predetermined period of time and a second predetermined period of time in a second embodiment.

FIG. 4 is a flowchart of a method of storing the cached data implemented by the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series and the like.

Embodiments of the present disclosure will be described with reference to the accompanying drawings.

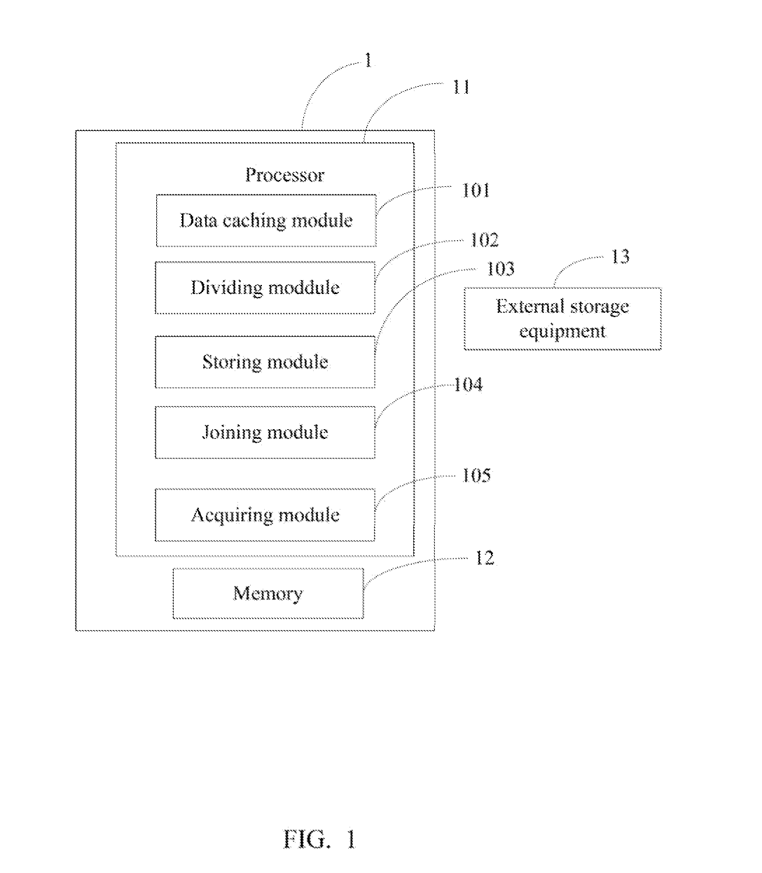

FIG. 1 illustrates an embodiment of an electronic device 1. The electronic device 1 includes a processor 11 and a memory 12. The electronic device 1 communicates with an external storage equipment 13. In one embodiment, the external storage equipment 13 is a hard disk. The processor 11 includes a data caching module 101, a dividing module 102, a storing module 103, a joining module 104, and an acquiring module 105 which are collections of software instructions and are executed by the processor 11.

The data caching module 101 caches video data to the memory 12 when a webpage is opened to play a network video.

The dividing module 102 divides the cached video data into a number of sub videos. Each sub-video includes a starting time and an ending time. The cached video data includes a first section of video data which has been already played, and a second section of video data which has not been played.

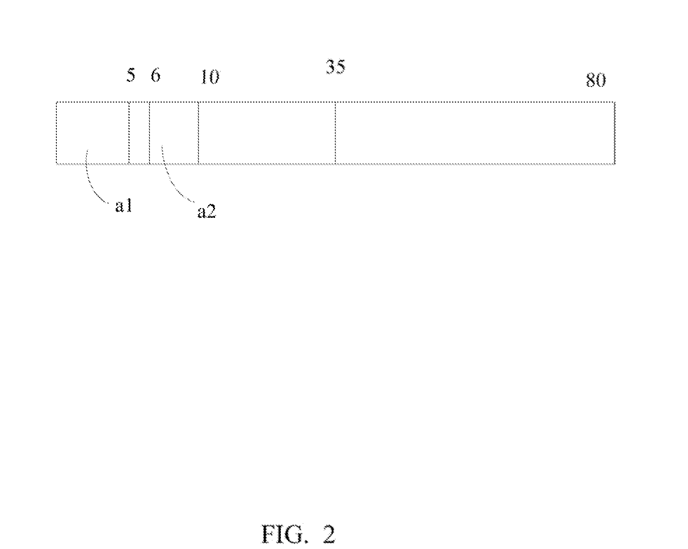

In a first embodiment, the dividing module 102 only divides the first section of video data into a number of sub-videos each of which has a same first duration. As shown in FIG. 2, a total playing time of the network video is 80 minutes, the network video has been cached for 35 minutes, and the cached video data has been played to 6 minutes. For example, when the first duration is set to 5 minutes, the dividing module 102 divides the first section of video data to obtain a first sub-video a1 from 0 to 5 minutes. When the cached video data has been played to 10 minutes, the dividing module 102 divides the remaining of the first section of video data to obtain a second sub-video a2 from 5 to 10 minutes, and so forth to divide the first section of video data to obtain a number of sub-videos each of which has the same first duration. Therein, the starting time of the sub-video a1 is 0, and the ending time of the sub-video a1 is at 5 minutes. The starting time of the sub-video a2 is at 5 minutes, and the ending time of the sub-video a2 is at 10 minutes.

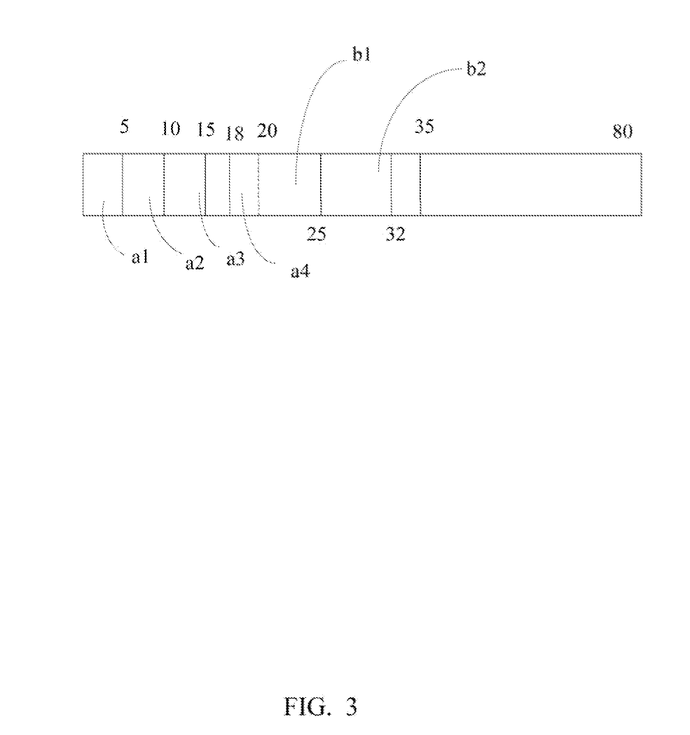

In a second embodiment, the dividing module 102 divides the first section of video data to obtain a number of sub-videos each of which has the same first duration, and divides the second section of video data to obtain a number of sub-videos each of which has a same second duration. As shown in FIG. 3, the total playing time of the network video is 80 minutes, the network video has been cached for 35 mintues, and the cached video data has been played to 18 minutes. For example, the first duration is set to 5 minutes, and the second duration is set to 7 minutes. The dividing module 102 divides the first section of video data to obtain a first sub-video a1 from 0 to 5 minutes, a second sub-video a2 from 5 to 10 minutes, and a third sub-video a3 from 10 to 15 minutes, and divides the second section of video data to obtain a first sub-video b1 from 18 to 25 minutes, and a second sub-video b2 from 25 to 32 minutes. Therein, the starting time of the sub-video a1 is 0, and the ending time of the sub-video a1 is at 5 minutes. The starting time of the sub-video a2 is at 5 minutes, and the ending time of the sub-video a2 is at 10 minutes. The starting time of the sub-video a3 is at 10 minutes, and the ending time of the sub-video a3 is at 15 minutes. The starting time of the sub-video b1 is at 18 minutes, and the ending time of the sub-video b1 is at 25 minutes. The starting time of the sub-video b2 is at 25 minutes, and the ending time of the sub-video b2 is at 32 minutes.

The storing module 103 transfers the number of sub-videos from the memory 12 to the external storage equipment 13 for storing. In the first embodiment, the storing module 103 transfers the first sub-videos a1 and a2 to the external storage equipment 13 for storing.

In the second embodiment, the storing module 103 transfers the first sub-videos a1, a2, a3, and the second sub-videos b1, b2 to the external storage equipment 13 for storing from the memory 12. Furthermore, because the duration of the remainder of the first section from 15 to 18 minutes is less than 5 minutes, the remainder of the first section is only stored in the memory 12, and has not been transferred to the external storage equipment 13 for storing. When the cached video data has been played to 20 minutes, a sub-video a4 from 15 to 20 minutes is obtained, and the sub-video a4 is transferred to the external storage equipment 13 for storing.

The joining module 104 joins the number of sub-videos from the external storage equipments 13 and the cached video data in the memory 12 based on the starting time and the ending time of the video data to form a joined video. In the first embodiment, the joining module 104 joins the sub-videos a1 and the cached video data from the 5th to 8th minutes to form the joined video. In the second embodiment, the joining module 104 joins the sub-videos a1, a2, a3, the cached video data from the 15th to 18th minutes, and the sub-videos b1, b2 to form the joined video.

The acquiring module 105 acquires the joined video when the user opens the webpage again. Furthermore, for example, the video is played to 18 minutes at a previous time. When the user opens the joined video, the joined video will resume play from 18 minutes.

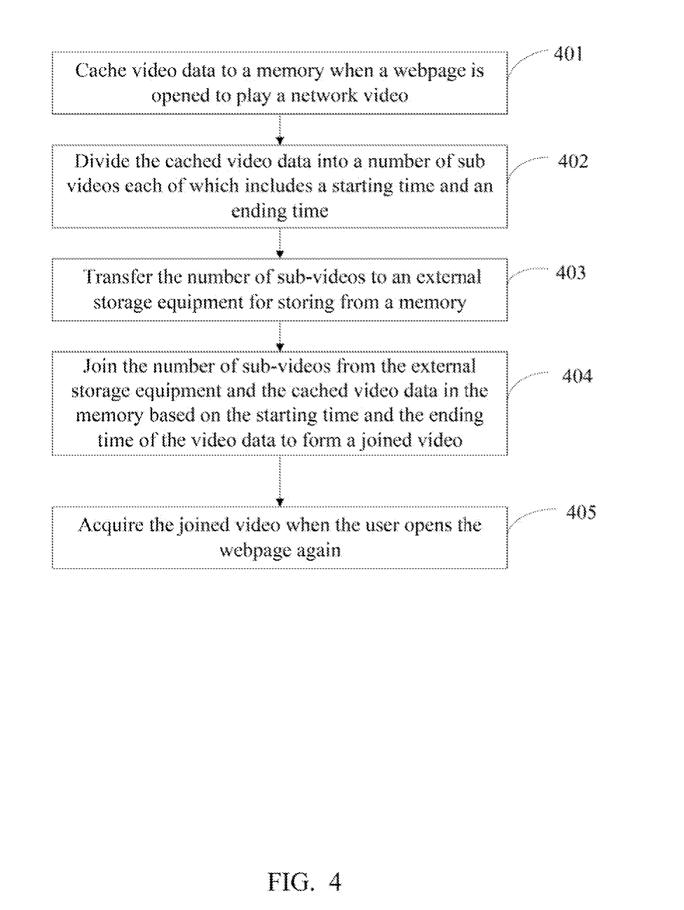

FIG. 4 is a flowchart of a method of storing the cached data implemented by the electronic device of FIG. 1.

In block 401, a data caching module caches video data to a memory when a webpage is opened to play a network video.

In block 402, a dividing module divides the cached video data into a number of sub-videos each of which includes a starting time and an ending time.

In block 403, a storing module transfers the number of sub-videos from a memory to an external storage equipment for storing.

In block 404, a joining module joins the number of sub-videos from the external storage equipments and the cached video data in the memory based on the starting time and the ending time of the video data to form a joined video.

In block 405, an acquiring module acquires the joined video when the user opens the webpage again.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims.

What is claimed is:

1. An electronic device with a data cache function comprising:
a memory; and
a processor configured to:
cache video data to the memory when a webpage is opened to play a network video;
divide the cached video data into a plurality of sub-videos each of which comprises a starting time and an ending time;
transfer the plurality of sub-videos from the memory to an external storage equipment for storing; and
join the plurality of sub-videos from the external storage equipment and the cached video data in the memory based on the starting time and the ending time of the video data to form a joined video.

2. The electronic device as described in claim 1, wherein the processor is further configured to acquire the joined video when the user opens the webpage again.

3. The electronic device as described in claim 1, wherein the cached video comprises a first section of video data which has been already played, the processor configured to divide the first section of video data to obtain the plurality of sub-videos each of which has a same first duration.

4. The electronic device as described in claim 1, wherein the cached video comprises a first section of video data which has been already played and a second section of video data which has not been played, the processor configured to divide the first section of video data to obtain a plurality of sub-videos each of which has a same first duration, and divide the second section of video data to obtain a plurality of sub-videos each of which has a same second duration.

5. A data caching method implemented by an electronic device, wherein the electronic device comprises a memory, the method comprising:
caching video data to the memory when a webpage is opened to play a network video;
dividing the cached video data into a plurality of sub-videos each of which comprises a starting time and an ending time;
transferring the plurality of sub-videos from the memory to an external storage equipment for storing; and
joining the plurality of sub-videos from the external storage equipment and the cached video data in the memory based on the starting time and the ending time of the video data to form a joined video.

6. The method as described in claim 5, further comprising:
acquiring the joined video when the user opens the webpage again.

7. The method as described in claim 5, wherein the cached video comprises a first section of video data which has been already played, the method further comprising:
dividing the first section of video data to obtain the plurality of sub-videos, each of which has a same first duration.

8. The method as described in claim 5, wherein the cached video comprises a first section of video data which has been already played and a second section of video data which has not been played, the method further comprising:
dividing the first section of video data to obtain a plurality of sub-videos each of which has a same first duration; and
dividing the second section of video data to obtain a plurality of sub-videos each of which has a same second duration.
